(19) United States
(12) Patent Application Publication
(10) Pub. No.: US 2026/0258818 A1
(43) Pub. Date: Sep. 3, 2026

(54) LIQUID RETENTION ASSEMBLIES FOR PUMPING SYSTEMS

(71) Applicant: OneSubsea IP UK Limited, London (GB)

(72) Inventors: Stig Kaare Kanstad, Sandsli (NO); Even Nordstoga, Sandsli (NO); Kyrre Aarsand Groenstoel, Sandsli (NO)

(21) Appl. No.: 19/552,460

(22) Filed: Feb. 27, 2026

Related U.S. Application Data
(60) Provisional application No. 63/765,011, filed on Feb. 28, 2025.

(51) Int. Cl. F04D 31/00

(52) U.S. Cl. CPC F04D 31/00

(57) ABSTRACT

An embodiment of a multi-phase pumping system includes a pump and a liquid retention assembly downstream of the pump. The liquid retention assembly is configured to extract and retain a volume of liquid from a multi-phase fluid that is discharged by the pump. The liquid retention assembly includes a recirculation outlet that is configured to provide a liquid-rich recirculation flow from the volume of liquid to the pump to reduce a gas volume fraction (GVF) at an inlet of the pump.

### CROSS-REFERENCE TO RELATED APPLICATIONS

This application claims priority to and the benefit of United States Provisional Patent Application Serial Number 63/765,011, filed February 28, 2025, and entitled “Flow Splitter and Method for Re-Circulation,” the contents of which are incorporated herein by reference.

### BACKGROUND

In the oil and gas industry, subsea production systems are critical for extracting hydrocarbons from underwater reservoirs, often operating under highly variable and unpredictable flow conditions. One of the most persistent challenges in these systems is maintaining the stability and efficiency of multi-phase pumps, which are required to handle mixtures of gas, oil, water, and occasionally solids. Among the disruptive flow phenomena encountered, slugging is particularly problematic. Slugging refers to the cyclic, intermittent arrival of large liquid slugs followed by extended periods of predominantly gas flow. These oscillations arise from a number of different sources, such as, without limitation, terrain-induced pressure instabilities, liquid holdup in low points of the flowline, or hydrodynamic interactions between phases within long subsea tiebacks.

### SUMMARY

Some embodiments disclosed herein are directed to a multi-phase pumping system that includes a pump and a liquid retention assembly downstream of the pump. The liquid retention assembly is configured to extract and retain a volume of liquid from a multi-phase fluid that is discharged by the pump. The liquid retention assembly includes a recirculation outlet that is configured to provide a liquid-rich recirculation flow from the volume of liquid to the pump to reduce a gas volume fraction (GVF) at an inlet of the pump.

Some embodiments disclosed herein are directed to a liquid retention assembly for a multi-phase pumping system. The liquid retention assembly includes a liquid retainer that is configured to extract and retain at least a portion of a volume of liquid from a multi-phase fluid discharged from a pump of the multi-phase pumping system up to a predetermined liquid level. The liquid retainer is configured to prevent liquid drainage below the predetermined liquid level. In addition, the liquid retention assembly includes a recirculation outlet in communication with the liquid retainer that is configured to provide a liquid-rich recirculation flow from the volume of liquid to the pump to reduce a gas volume fraction (GVF) at an inlet of the pump.

Some embodiments disclosed herein are directed to a method including (a) discharging a multi-phase fluid from a pump. In addition, the method includes (b) receiving the multi-phase fluid into a liquid retention assembly after (a). Further, the method includes (c) separating and retaining a liquid from the multi-phase fluid in the liquid retention assembly. Still further, the method includes (d) recirculating at least some of the liquid from the liquid retention assembly to the pump to reduce a gas volume fraction (GVF) at an inlet of the pump.

### BRIEF DESCRIPTION OF THE DRAWINGS

The subject disclosure is further described in the following detailed description, and the accompanying drawings and schematics of non-limiting embodiments of the subject disclosure. The features depicted in the figures are not necessarily shown to scale. Certain features of the embodiments may be shown exaggerated in scale or in somewhat schematic form, and some details of elements may not be shown in the interest of clarity and conciseness. These and other features, aspects, and advantages of various exemplary embodiments will become better understood when the following detailed description is read with reference to the accompanying drawings in which like characters represent like parts throughout the drawings, wherein:

FIG. 1 is a schematic diagram of a subsea multi-phase pumping system according to some embodiments disclosed herein;

FIG. 2 is a cross-sectional view of a liquid retainer that may be utilized as at least a portion of the liquid retention assembly of FIG. 1 according to some embodiments disclosed herein;

FIG. 3 is a cross-sectional view of another liquid retainer that may be utilized as at least a portion of the liquid retention assembly of FIG. 1 according to some embodiments disclosed herein; and

FIG. 4 is a schematic diagram of another liquid assembly for use in the pumping system of FIG. 1 according to some embodiments disclosed herein.

### DETAILED DESCRIPTION

A multi-phase pumping system, such as a pumping system for subsea oil and gas production, may experience slugging, which causes rapid and significant fluctuations in pressure, flow rate, and gas volume fraction (GVF) at an inlet of the pump. During a liquid slug phase, the pump may experience sudden increases in differential pressure and torque load, while the subsequent gas-rich phase can severely reduce the inlet density and available suction head. These shifts can push the pump outside its stable operating envelope, resulting in reduced efficiency, decreased head generation, and potential stalling or surge. In extreme cases, high GVF conditions may cause the pump to lose the ability to build pressure altogether, triggering automatic protective shutdowns or pump trips. Such trips interrupt production, stress upstream infrastructure, and increase operational costs, making slug management a fundamental requirement for reliable subsea pump system performance. Typically, slugging is mitigated by employing various flow mixers and splitters upstream of the pump; however, these traditional solutions increase the cost, complexity, and footprint of the pumping system.

Accordingly, embodiments disclosed herein include subsea multi-phase pumping systems equipped with liquid retention assemblies positioned downstream of the pump(s). The liquid retention assemblies are configured to extract and retain a volume of liquid for selective recirculation back to the pump during operations. This recirculated liquid stream may stabilize pump inlet conditions and mitigate the fluctuations in liquid and gas content that otherwise contribute to operational inefficiencies and pump trips. In some embodiments, the liquid retention assemblies include a plurality of liquid retention assemblies that are connected in series or in parallel downstream of the pump to increase the capacity of the system to extract and retain liquid for recirculation. Through use of the embodiments disclosed herein, subsea multi-phase pumping systems can achieve improved operational performance without materially increasing system cost, complexity, or footprint.

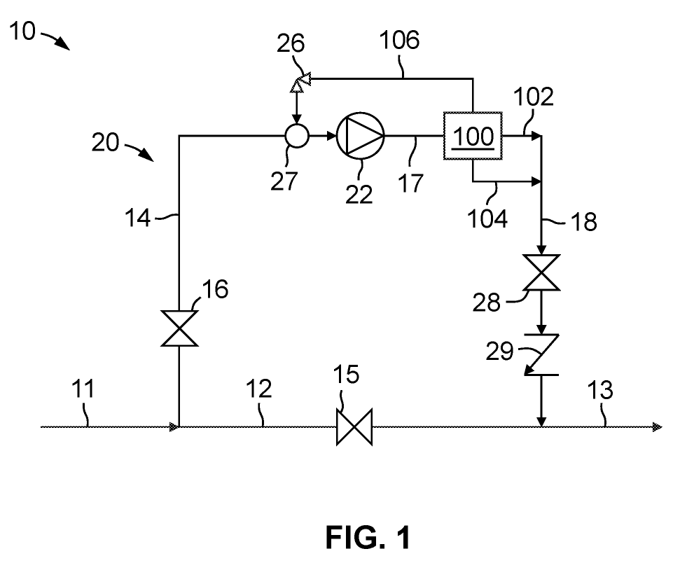

Reference is now made to FIG. 1, which schematically illustrates a subsea multi-phase pumping system 10 (“pumping system 10”) according to some embodiment disclosed herein. The pumping system 10 may be used to boost unprocessed mixtures of oil, gas, and water in a subsea environment, such as on the seabed. In some embodiments, the pumping system 10 may receive a flow of fluid from a subsea well, a subsea pipeline, a subsea storage facility, or some combination thereof. In some circumstances, the pumping system 10 may be referred to as a “pumping station” for a subsea pipeline or other infrastructure. As will be described in more detail herein, the pumping system 10 includes a liquid retention assembly 100 that is configured to extract and retain a volume of liquid to provide a liquid-rich recirculation flow to stabilize the operation of the pumping system 10 despite changes in the GVF of the incoming fluid (such as due to slugging).

The pumping system 10 may include an inlet 11, an outlet 13, and a pumping circuit 20 in fluid communication between the inlet 11 and the outlet 13. A bypass line 12 may also be in fluid communication between the inlet 11 and the outlet 13 in parallel with the pumping circuit 20. The bypass line 12 includes a bypass valve 15 that is configured to selectively adjust (such as allow, prevent, or restrict) a flow of fluid along the bypass line 12.

The pumping circuit 20 includes a pump 22, a suction line 14 that extends from the inlet 11 to the pump 22, and a discharge line 17 that extends downstream from the pump 22. The liquid retention assembly 100 is in fluid communication with the discharge line 17 and is therefore also positioned downstream of the pump 22. In addition, the pumping circuit 20 includes an outflow line 18 that extends from the liquid retention assembly 100 to the outlet 13.

An inlet control valve 16 is positioned along the suction line 14, upstream of the pump 22. Similarly, an outlet valve 28 is positioned on the outflow line 18, downstream from the liquid retention assembly 100. Further, a check valve 29 is positioned on the outflow line 18, such as downstream of the outlet valve 28. During operations, the inlet control valve 16 and outlet valve 28 may be selectively adjusted (such as by a controller, a remotely operated vehicle (ROV), etc.) to control a flow of fluid through the pumping circuit 20. The check valve 29 may prevent (or at least restrict) a back flow of fluid from the outlet 13 to the pump 22 but may allow fluid to flow from the outflow line 18 and into the outlet 13.

The liquid retention assembly 100 may receive the fluid discharged from the pump 22 via the discharge line 17. In addition, the liquid retention assembly 100 may include one or more liquid retainers that are configured to at least partially extract and retain liquid from the fluid discharged from the pump 22. The liquid retention assembly 100 may include a gas outlet 102, a liquid outlet 104, and a recirculation outlet 106. The gas outlet 102 and liquid outlet 104 may be in fluid communication with the outflow line 18, and the recirculation outlet 106 may is fluid communication with the suction line 14, upstream of the pump 22 via a choke valve 26 and a mixer 27. The mixer 27 may comprise one or more vessels or other structures that are configured to mix the incoming fluid in the suction line 14 with the liquid-rich fluid that is discharged from the recirculation outlet 106 of the liquid retention assembly 100.

During operations, the liquid retention assembly 100 may extract (or separate) and retain a volume of liquid from the fluid discharged by the pump 22. The retained liquid may be selectively flowed back to the suction line 14 via the recirculation outlet 106 and the choke valve 26 and mixer 27 to provide or maintain a desired GVF (or a GVF within a desired range) at the inlet of the pump 22. In some embodiments, the flow rate through the recirculation outlet 106 to the suction line 14 from the liquid retention assembly 100 may be controlled by a position of the choke valve 26. Gas and additional liquid (that is, liquid in additional to a volume of liquid that is retained in the liquid retention assembly 100) may be output from the liquid retention assembly 100 to the outflow line 18 via the gas outlet 102 and liquid outlet 104, respectively. Therefore, if a GVF of the fluid flowing into the suction line 14 from the inlet 11 increases above a threshold (such as in the case of a long gas bubble in the fluid entering the pumping assembly via the inlet 11), additional liquid may be provided to the suction line 14 via the recirculation outlet 106 to decrease the GVF at the inlet of the pump 22 and therefore stabilize the operation of the pump 22. In some embodiments, the liquid retention assembly 100 provides sufficient stabilization of the inlet conditions of the pump 22 such that conventional upstream slug-mitigation equipment, including slug catchers, flow mixers, or flow conditioners, may be reduced, replaced, or entirely eliminated.

In some embodiments, the liquid retention assembly 100 may further enhance the performance of the pump 22 by expanding the operating envelope of the pumping system 10 under high‑gas‑fraction and low‑flow conditions. As previously described, the pumping system 10 may be configured to pressurize a fluid outflowing from a subsea oil and gas well. During mid‑life and late‑life production from such as well, conditions commonly require recirculation to maintain the pump 22 within its stable operating range. By ensuring that the recirculated flow provided from the liquid retention assembly 100 comprises a liquid‑rich stream, the GVF at the pump inlet may be reduced, thereby increasing the available head and enabling higher production rates compared to systems that do not incorporate a liquid retention mechanism. In some embodiments, the pump 22 may be configured to operate at a higher efficiency when an incoming fluid has a relatively low GVF.

The liquid retention assembly 100 may be particularly beneficial when water is present within the produced fluids; however, a heavy water content of the incoming fluid is certainly not required to enjoy the various benefits disclosed herein. In some embodiments, if the pressure and temperature conditions downstream of the pump 22 are below the bubble point, the composition of the liquid returning to the pump 22 via the recirculation outlet 106 may shift towards heavier hydrocarbons. Under such conditions, there is reduced flashing across the choke valve 26 and the liquid returned to the pump 22 remains rich in heavier constituents, with more volatile hydrocarbons exiting the liquid retention assembly 100 via the gas outlet 102.

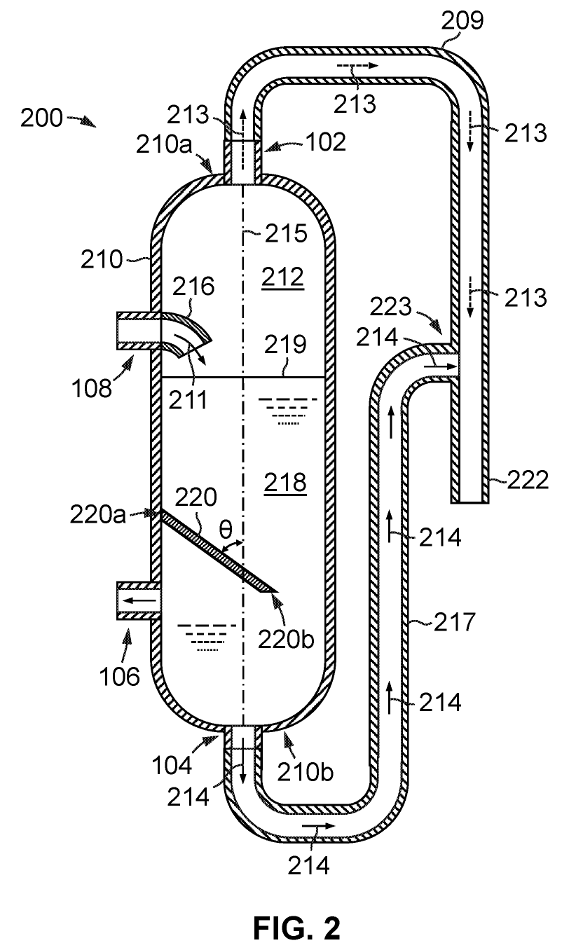

Reference is now made to FIG. 2, which illustrates a cross-sectional view of a liquid retainer 200 that may be utilized as the liquid retention assembly 100of FIG. 1 (or at least a portion thereof) according to some embodiments disclosed herein. The liquid retainer 200 shown in FIG. 2 is a vessel that includes a body 210 that defines a chamber (or volume) 212 therein. The body 210 includes a central or longitudinal axis 215 (“axis 215”), a first or upper end 210a, and a second or lower end 210b opposite the upper end 210a along the axis 215. In some embodiments, the body 210 may be oriented so that the upper end 210a is vertically higher than the lower end 210b. Specifically, in some embodiments, the axis 215 may be aligned (or substantially aligned) with the direction of the force of gravity. Thus, the axis 215 may be referred to as a “vertical axis.”

The body 210 may also define or include the gas outlet 102 and the liquid outlet 104. The gas outlet 102 may be positioned on (or proximate to) to the upper end 210a and the liquid outlet 104 may be positioned on (or proximate to) the lower end 210b. Thus, the gas outlet 102 may be positioned vertically higher than the liquid outlet 104 on the body 210. In some embodiments, the gas outlet 102 and liquid outlet 104 may both be aligned with the axis 215 and thus may be positioned on axially opposite ends of the body 210; however, other arrangements and configurations are contemplated.

The body 210 may also define an inlet 108 that may be coupled to the discharge line 17 downstream of the pump 22 (FIG. 1). The inlet 108 may be positioned axially between the gas outlet 102 and the liquid outlet 104 on the body 210. Thus, in some embodiments, the inlet 108 may be positioned vertically lower than the gas outlet 102 and vertically higher than the liquid outlet 104. However, other configuration are contemplated.

The inlet 108 may be coupled to a flow guide 216 that is positioned in the chamber 212. The flow guide 216 may be configured to deflect or guide fluid 211 entering the chamber 212 toward the lower end 210b of the body 210. In some embodiments, the flow guide 216 may comprise a piping elbow or partial elbow that is configured to direct incoming fluid 211 axially toward the lower end 210b during operations.

The body 210 may also define or include the recirculation outlet 106. In some embodiments, the recirculation outlet 106 may be positioned between the inlet 108 and the lower end 210b. For instance, in some embodiments, the recirculation outlet 106 may be positioned axially between the inlet 108 and the liquid outlet 104. In addition, the recirculation outlet 106 may be positioned on the same side, such as on the same circumferential half, of the body 210 as the inlet 108. For instance, in some embodiments, the recirculation outlet 106 may be circumferentially aligned with the inlet 108 about the axis 215; however, other configurations are contemplated.

A weir or baffle 220 may be positioned in the chamber 212. The weir 220 maybe positioned axially between the inlet 108 and the lower end 210b. Thus, the weir 220 may be positioned vertically below the inlet 108 according to some embodiments. As a result, the flow guide 216 may direct fluid 211 flowing into the chamber 212 via the inlet 108 toward the weir 220.

The weir 220 may be configured to deflect fluid 211 flowing into the chamber 212 via inlet 108 generally away from the recirculation outlet 106. For instance, the weir 220 may comprise a flat plate that includes a first or proximal end 220a and a second or distal end 220b. The proximal end 220a may be engaged or secured to an inner wall of the body 210 (that is, an inner wall that defines the chamber 212), and the distal end 220b may be projected into the chamber 212.

In some embodiments, the proximal end 220a of the weir 220 may be engaged or secured to the inner wall of the body 210 on the same side, such as the same circumferential side, of the body 210 as the recirculation outlet 106. Thus, the distal end 220b may be projected away from the recirculation outlet 106 within the chamber 212.

The weir 220 may be oriented at a non-zero angle θ relative to the axis 215. In some embodiments, the angle θ may be in a range that is greater than about 0° and less than or equal to about 90°. The weir 220 may be oriented at the non-zero angle θ so that the distal end 220b is projected toward the lower end 210b and away from the upper end 210a within the chamber 212.

During operations, the weir 220 may be configured to at least partially block or restrict direct fluid flow within the chamber 212 from the inlet 108 toward the recirculation outlet 106. Accordingly, the weir 220 may generally redirect (or deflect) fluid 211 entering the chamber 212 from the inlet 108 away from the recirculation outlet 106. As fluid 211 enters the chamber 212, it is initially guided axially toward the lower end 210b by the flow guide 216, as previously described. From there, the weir 220 may direct the fluid, such as by deflecting it radially relative to the axis 215, away from the recirculation outlet 106. The fluid may then pass beyond the distal end 220b of the weir 220 and collect or accumulate in a lower region of the chamber 212, at or proximate to the lower end 210b.

As previously described, the fluid 211 delivered from the pump 22 (FIG. 1) to the chamber 212 through the inlet 108 may comprise a multi-phase fluid including gas and liquid. Without being limited to this or any other theory, directing the incoming fluid 211 downward via the flow guide 216 may urge the mixture away from the gas outlet 102. This configuration may allow the heavier components of the fluid 211, namely the liquid phase and any entrained solids, to gravitate toward the lower end 210b, while permitting the lighter gaseous components to separate and migrate upward toward the gas outlet 102 as a gas-rich stream 213. The gas outlet 102 may be coupled to an output 222 of the liquid retention assembly 100 via piping 209. The output 222 may be coupled to the outflow line 18 of the pumping system of FIG. 1 as previously described.

Conversely, the heavier liquid-rich components of the incoming fluid 211 may accumulate in the chamber 212 at and proximate the lower end 210b. This liquid-rich fraction may exit the chamber 212 via the liquid outlet 104 as a liquid-rich stream 214. The liquid outlet 104 may be coupled to piping 217 that extends from the liquid outlet 104 to a junction 223 with the piping 209, upstream of the output 222. Thus, the liquid-rich stream 214 may flow from the liquid outlet 104, through the piping 217 and then may remix with the gas-rich stream 213 in the piping 209 at the junction 223 so that the remixed (or mixing) streams 213, 214 may exit the liquid retention assembly 100 via the output 222.

As may be appreciated in FIG. 2, the junction 223 may be located axially (or vertically) above the liquid outlet 104 and also the recirculation outlet 106. As a result, the height of the junction 223 above the liquid outlet 204 may define a minimum liquid head pressure in the liquid retainer 200 that will cause the liquid-rich stream 214 to advance out of the piping 217 and into the piping 209 via the junction 223. During operations, this minimum liquid head pressure may allow liquid to collect or accumulate in the chamber 212 until the liquid level 219 reaches (or substantially reaches) the height of the junction 223. Thus, the height difference between the junction 223 and liquid outlet 104 may allow the liquid retainer to retain or hold a liquid volume 218 in the chamber 212 during operations. In addition, the height of the junction 223 may defined a predetermined liquid level 219 in the chamber 212.

Once the volume of liquid 218 has accumulated within the chamber 212 to the predetermined liquid level 219, the retainer 200 may prevent (or at least resist) draining off this liquid volume 218 below the predetermined liquid level 219, even during prolonged periods of gas-rich fluid 211 entering the chamber 212 via inlet 108. Specifically, liquid drainage out of the chamber 212 via the liquid outlet 104 may be facilitated by additional liquid inflow into the chamber 212 via the inlet 108 that would increase the liquid level 219 above the junction 223 (or above the predetermined liquid level). However, periods of heavy gas inflow into the chamber 212 may not increase (or may not significantly increase) the liquid head pressure of the liquid volume 218 because the gas may freely exit the chamber 212 via the gas outlet 102. Thus, the arrangement of the liquid outlet 104 and junction 223 may be configured to maintain or retain the liquid volume 218 in the chamber 212 during operations.

This retained liquid volume 218 may also be in fluid communication the recirculation outlet 106. As a result, a portion of the retained liquid volume 218 may be directed back to the inlet of the pump 22 through the recirculation outlet 106 via the choke valve 26 and mixer 27 (FIG. 1), as previously described.

In some embodiments, the weir 220 may also promote the movement of solids entrained in the fluid 211 entering the chamber 212 via the inlet 108 away from the recirculation outlet 106 and toward the liquid outlet 104. Specifically, because the distal end 220b of the weir 220 extends away from the recirculation outlet 106, the fluid 211 and any entrained solids flowing along the weir 220 are deflected in a direction that steers them away from the recirculation outlet 106 within the chamber 212. As a result, such solids may be encouraged to exit the chamber 212 via the liquid outlet 104 rather than through the recirculation outlet 106. Accordingly, the liquid retention assembly 100 may be configured to limit the amount of solids recirculated back to the pump 22 (FIG. 1) during operation.

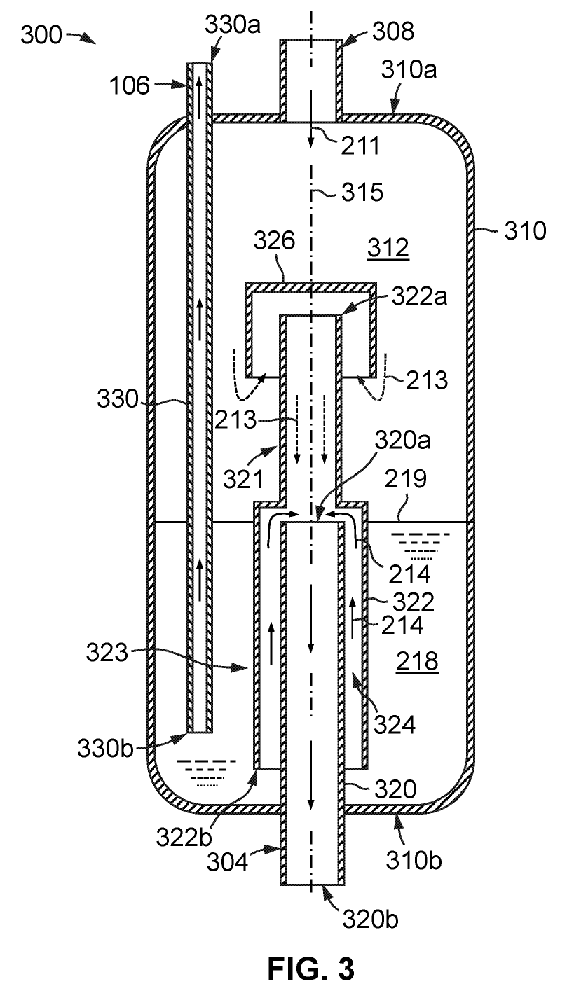

Reference is now made to FIG. 3, which illustrates a cross-sectional view of another liquid retainer 300 that may be utilized as the liquid retention assembly 100 of FIG. 1 (or at least a portion thereof) according to some embodiments disclosed herein. The liquid retainer 300 shown in FIG. 3 is a vessel that includes a body 310 that defines a chamber (or volume) 312 therein. The body 310 includes a central or longitudinal axis 315 (“axis 315”), a first or upper end 310a, and a second or lower end 310b opposite the upper end 310a along the axis 315. In some embodiments, the body 310 may be oriented so that the upper end 310a is vertically higher than the lower end 310b. Specifically, in some embodiments, the axis 315 may be aligned (or substantially aligned) with the direction of the force of gravity. Thus, the axis 315 may be referred to as a “vertical axis.”

The body 310 may define an inlet 308 that may be coupled to the discharge line 17 downstream of the pump 22 (FIG. 1). The inlet 308 may be positioned at (or proximate to) the upper end 310a so that incoming fluid 211 is directed generally axially downward into the chamber 312 along axis 315.

In contrast to the liquid retainer 200 shown in FIG. 2, the liquid retainer 300 incorporates internal flow paths formed within the body 310, eliminating the need for external piping 209, 217, and the junction 223 while enabling extraction and retention of the liquid volume 218 during operation. Specifically, an outlet tube 320 may extend axially through the lower end 310b of the body 310 to define a combined outlet 304 for mixed (or mixing) liquid-rich stream 214 and gas-rich stream 213 as previously described. Thus, the outlet 304 may be coupled to the outflow line 18 of the pumping system of FIG. 1 as previously described. The outlet tube 320 may extend from a first or upper end 320a that is positioned within the body 310 to a second or lower end 320b that is positioned outside of the body 310. The upper end 320a may be positioned axially part-way between the ends 310a, 310b along axis 315.

A sleeve 322 is positioned within the body 310 and around the outlet tube 320. The sleeve 322 may be entirely positioned within the body 310 and may extend from a first or upper end 322a to a lower end 322b. The lower end 322b may be positioned more axially proximate to the lower end 310b of the body 310 than the upper end 322a, and the upper end 322a may be positioned more axially proximate to the upper end 310a of the body 310 than the lower end 322b.

The upper end 320a of the outlet tube 320 may be received part-way into the sleeve 322 so that the upper end 320a of the outlet tube 320 is positioned axially between the ends 322a, 322b of the sleeve 322. An annulus (or annular flow path) 324 may be defined radially between the sleeve 322 and the outlet tube 320 that extends axially between the lower end 322b of the sleeve 322 and the upper end 320a of the outlet tube 320.

As is illustrated in FIG. 3, in some embodiments, the sleeve 322 may have an upper portion 321 that extends from the upper end 322a and a lower portion 323 that extends from the upper portion 321 to the lower end 322b. The upper portion 321 may have a smaller diameter (such as a smaller outer diameter and inner diameter) than the lower portion 323. The annulus 324 may be defined radially between the outlet tube 320 and the lower portion 323 of the sleeve 322. In addition, the inner diameter of the upper portion 321 may be the same (or substantially the same) as the inner diameter of the outlet tube 320.

A cap 326 may be positioned in the body 310, on or above the upper end 322a of the sleeve 322. The cap 326 may be positioned so that fluid (such as the gas-rich stream 213) may flow from the chamber 312, around the cap 326, and into the upper end 322a of the sleeve 322 during operations. Thus, the cap 326 may be spaced from the upper end 322a or the cap 326 or sleeve 322 may include one or more holes, ports, or slots, among other examples.

During operations, the incoming fluid 211 may flow into the chamber 312 via the inlet 308 as previously described. The fluid 211 may comprise a multi-phase mixture of both gas and liquid as previously described. This multi-phase mixture may advance axially downward within the chamber 312 so that gaseous components may at least partially separate from the heavier components (such as liquids and possibly solids) in the fluid 211. The lighter, separated gases may flow over and/or through the cap 326 and into the upper end 322a of the sleeve 322, while the heavier liquid-rich components (and any solids entrained therein) are encouraged to collect within a lower portion of the chamber 312, such as at or proximate to the lower end 310b. The gases may then flow axially downward through the sleeve 322 as the gas-rich stream 213 and then may progress into the upper end 320a of the outlet tube 320 and out the outlet 104.

The collected liquid fraction in the lower portion of the chamber 312 may progress into the annulus 324 via the lower end 322b of the sleeve 322 as a liquid-rich stream 214 that eventually spills or drains into the upper end 320a where it mixes with the gas-rich stream 213 and flows out via the outlet 104. The smaller cross-section of the annulus 324 may accelerate the outflowing liquid stream 214 so as to at least partially sweep or carry any solids (such as sands) out of the chamber 310 and into the outlet tube 320 during operations. In addition, without being limited to this or any other theory, configuring the inner diameter of the upper portion 321 of the sleeve 322 to be the same (or substantially the same) as the inner diameter of the outlet tube 320 may help to ensure a positive flow of the liquid-rich stream 214 from the annulus 324 into the outlet tube 320 and to prevent the gas-rich stream 213 from flowing into the annulus 324 during operations.

Thus, like the junction 233 of the liquid retainer 200 of FIG. 2, the height of the upper end 320a of the outlet tube 320 may define a minimum head pressure in the liquid retainer 300 that will cause the liquid-rich stream 214 to advance into the outlet tube 320 and out via the outlet 104. As a result, this minimum liquid head pressure may allow liquid to collect or accumulate in the chamber 312 until the liquid level 219 reaches (or substantially reaches) the height of the upper end 320a of the outlet tube 320 to therefore retain the liquid volume 218 in the chamber 312. Thus, the height of the upper end 320a of the outlet tube 320 may define a predetermined liquid level 219 in the chamber 312.

Similar to the liquid retainer 200 of FIG. 2, the liquid retainer 300 may be configured to prevent (or at least resist) draining off this liquid volume 218 below the predetermined liquid level 219 defined by the upper end 320a of the outlet tube 320, even during prolonged periods of gas-rich fluid 211 entering the chamber 312 via inlet 308. Specifically, liquid drainage out of the chamber 312 via the outlet tube 320 may be facilitated by additional liquid inflow into the chamber 312 via the inlet 308 that would increase the liquid level 219 above the height of the upper end 320a. However, periods of heavy gas inflow into the chamber 312 may not increase (or may not significantly increase) the head pressure of the liquid volume 218 because the gas may freely exit the chamber 312 via the upper end 322a of sleeve 322 and upper end 320a of outlet tube 320. Thus, the arrangement of the outlet tube 320 and sleeve 322 may be configured to maintain or retain the liquid volume 218 in the chamber 312 at the predetermined liquid level 219 during operations.

The liquid retainer 300 may also include a second outlet tube 330 that extends out of body 310 and that defines the recirculation outlet 106. The outlet tube 330 may include a first or upper end 330a and a second or lower end 330b. The upper end 330a may be positioned outside of the body 310, and may define the recirculation outlet 106, while the lower end 330b is positioned inside of the body 310. Specifically, the lower end 330b of the second outlet tube 330 may be positioned axially closer to the lower end 310b than the upper end 310a. The lower end 330b may be positioned in the chamber 312 so that it is below the predetermined liquid level 219 of the liquid volume 218 (such as below the upper end 320a of the outlet tube 320).

Thus, the lower end 330b of the second outlet tube 330 may be in communication with the liquid volume 218. As a result, a portion of the retained liquid volume 218 may be directed back to the pump 22 through the second outlet tube 330, the recirculation outlet 106 via the choke valve 26 and mixer 27 (FIG. 1), as previously described.

In some embodiments, the liquid retention assembly 100 may comprise a plurality of liquid retainers (such as one or more of the liquid retainers 200, 300 described herein) that connected in series or in parallel to one another. Thus, in some embodiments, a plurality of the liquid retainers 200, a plurality of the liquid retainers 300, or one or more of the liquid retainers 200 and one or more of the liquid retainers 300 may be connected (again in series or in parallel) to at least partially define the liquid retention assembly 100 according to some embodiments. In some embodiments, one or more of the liquid retainers 200 and/or one or more of the liquid retainers 300 may be coupled to additional vessels (such as separators, splitters, retainers, etc.) to define embodiments of the liquid retention assembly 100.

Without being limited to this or any other theory, connecting multiple vessels to one another in the manner previously described, may increase the capacity of the liquid retention assembly 100 to extract and retain liquid when total flow rate and GVF are elevated for the incoming fluid. As a result, use of a plurality of interconnected vessels may maintain a sufficiently liquid‑rich recirculation stream back to the pump 22 during more demanding operating scenarios. Such a configuration may also reduce overall system cost when deployed in applications requiring high flow‑handling capability.

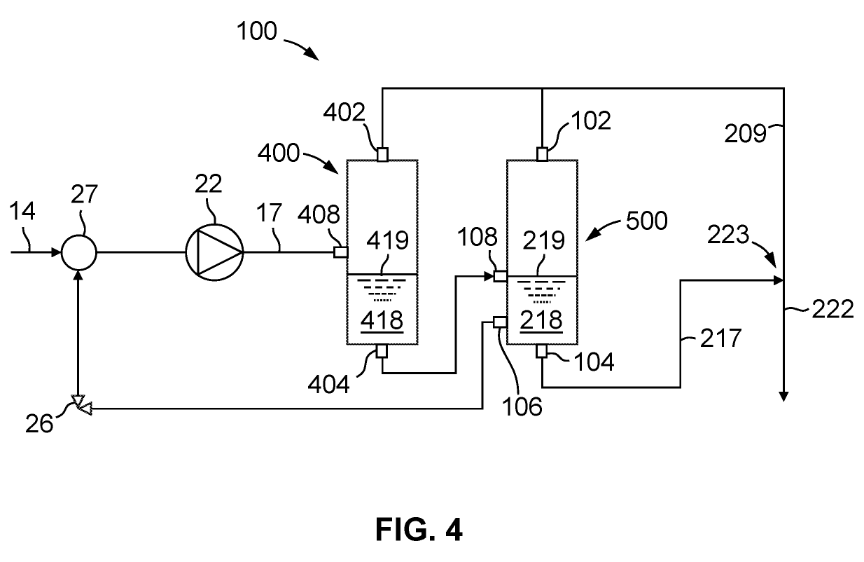

For instance, FIG. 4 shows a schematic diagram of the liquid retention assembly 100 according to some embodiments. In addition, FIG. 4 also illustrates the suction line 14, choke valve 26, mixer 27, pump 22, and discharge line 17 of the pumping system 10 of FIG. 1.

In the embodiment illustrated in FIG. 4, the liquid retention assembly 100 includes a pair of liquid retainers 400, 500 that are coupled in series. In the illustration of FIG. 4, the liquid retainer 500 is configured similarly to the liquid retainer 200 of FIG. 2; however, it should be appreciated that either the liquid retainer 400 or the liquid retainer 500 may be configured similar to the liquid retainer 300 of FIG. 3. Thus, the depiction of the liquid retainer 500 as being similarly configured to the liquid retainer 200 of FIG. 2 is merely illustrative of some embodiments and should not be interpreted as limiting other embodiments.

The liquid retainer 500 may include the gas outlet 102, liquid outlet 104, inlet 108, and recirculation outlet 106 as previously described. In addition, the liquid retainer 500 may output the gas-rich stream (not shown, but see stream 213 in FIG. 2) and the liquid-rich stream 214 (not shown, but see stream 214 in FIG. 2) to the junction 223 and output 222 in the manner previously described for the liquid retainer 200. Thus, as previously described, the height difference between the junction 223 and the liquid outlet 104 may define the predetermined liquid level 219 of the liquid volume 218 that is retained in the liquid retainer 500 during operations.

In addition, the liquid retainer 400 may be coupled in series with the liquid retainer 500 so that the liquid retainer 400 is upstream of the liquid retainer 500 and downstream of the pump 22. The liquid retainer 400 may include a vessel that has an inlet 408, a gas outlet 402, and a liquid outlet 404. The gas outlet 402 may be positioned vertically higher than the liquid outlet 404. Thus, during operations, as mixed-phase fluid flows into the liquid retainer 400, the lighter gaseous components may separate and rise toward the gas outlet 402 and the heavier liquid (and possibly solid) components may separate and fall toward the liquid outlet 404.

The gas outlet 402 may be coupled to the piping 209 that is coupled to the gas outlet 102 of the liquid retainer 500. Thus, gases that are flowing out of the liquid retainer 400 via the gas outlet 402 may join and mix with the gases flowing out of the liquid retainer 500 via gas outlet 102.

Conversely, the liquid outlet 404 may be coupled to the inlet 108 of the liquid retainer 500. The inlet 108 of the liquid retainer 500 may be positioned vertically higher (or above) than the liquid outlet 404. As a result, in a similar manner to that described above for the liquid retainers 200, 300, the height difference between the liquid outlet 404 and the inlet 108 may define a predetermined liquid level 419 for a liquid volume 418 that is retained in the liquid retainer 400 during operations.

Thus, by connecting the liquid retainers 400, 500 to one another (such as in series as shown in FIG. 4), the combined liquid volumes 418, 218 retained in the liquid retainers 400, 500 may increase the total capacity of extracted and retained liquid int the liquid retention assembly 100 that may be recirculated back to the pump 22 via the recirculation outlet 106, choke valve 26, and mixer 27 as previously described.

As explained above and reiterated below, the present disclosure includes, without limitation, the following Examples.

Example 1: A multi-phase pumping system comprising: a pump; and a liquid retention assembly downstream of the pump, where the liquid retention assembly is configured to extract and retain a volume of liquid from a multi-phase fluid that is discharged by the pump, and where the liquid retention assembly includes a recirculation outlet that is configured to provide a liquid-rich recirculation flow from the volume of liquid to the pump to reduce a gas volume fraction (GVF) at an inlet of the pump.

Example 2: The multi-phase pumping system of any of the Examples, where the liquid retention assembly comprises a liquid retainer that is configured to retain at least a portion of the volume of liquid up to a predetermined liquid level and that is configured to prevent liquid drainage below the predetermined liquid level in the liquid retainer.

Example 3: The multi-phase pumping system of any of the Examples, where the liquid retainer comprises: a body defining a chamber; a liquid outlet out of the chamber; and a gas outlet out of the chamber that is positioned above the liquid outlet, where the gas outlet and the liquid outlet are coupled to one another at a junction positioned outside of the body, and where the junction is positioned above the liquid outlet such that a height of the junction defines the predetermined liquid level in the liquid retainer.

Example 4: The multi-phase pumping system of any of the Examples, where the liquid retainer further comprises a weir that is positioned inside the chamber and that is configured to deflect fluid away from the recirculation outlet.

Example 5: The multi-phase pumping system of any of the Examples, where the liquid retainer further comprises an inlet into the chamber that is coupled to the pump, where the inlet into the chamber includes a flow guide that is configured to direct fluid flowing into the chamber toward the weir.

Example 6: The multi-phase pumping system of any of the Examples, where the liquid retainer comprises: a body defining a chamber; and an outlet tube including an upper end positioned inside of the body and a lower end positioned outside of the body, where a height of the upper end of the outlet tube in the chamber is configured to define the predetermined liquid level in the liquid retainer.

Example 7: The multi-phase pumping system of any of the Examples, where the liquid retainer further comprises a sleeve positioned around the upper end of the outlet tube within the chamber such that an annulus is defined between the sleeve and the outlet tube within the chamber, and where the annulus is configured to be in fluid communication with the volume of liquid.

Example 8: The multi-phase pumping system of any of the Examples, where the liquid retainer further comprises a second outlet tube that defines the recirculation outlet.

Example 9: The multi-phase pumping system of any of the Examples, where the liquid retention assembly comprises a plurality of liquid retainers that are downstream of the pump, where each of the plurality of liquid retainers is configured to retain a corresponding portion of the volume of liquid.

Example 10: The multi-phase pumping system of any of the Examples, where the plurality of liquid retainers are connected in series, downstream of the pump.

Example 11: The multi-phase pumping system of any of the Examples, where the plurality of liquid retainers are connected in parallel, downstream of the pump.

Example 12: The multi-phase pumping system of any of the Examples, where each liquid retainer of the plurality of liquid retainers is configured to prevent liquid drainage below a predetermined liquid level in the liquid retainer.

Example 13: A liquid retention assembly for a multi-phase pumping system, the liquid retention assembly comprising: a liquid retainer that is configured to extract and retain at least a portion of a volume of liquid from a multi-phase fluid discharged from a pump of the multi-phase pumping system up to a predetermined liquid level, where the liquid retainer is configured to prevent liquid drainage below the predetermined liquid level; and a recirculation outlet in communication with the liquid retainer that is configured to provide a liquid-rich recirculation flow from the volume of liquid to the pump to reduce a gas volume fraction (GVF) at an inlet of the pump.

Example 14: The liquid retention assembly of any of the Examples, where the liquid retainer comprises: a body defining a chamber; a liquid outlet out of the chamber; and a gas outlet out of the chamber that is positioned above the liquid outlet, where the gas outlet and the liquid outlet are coupled to one another at a junction positioned outside of the body, and where the junction is positioned above the liquid outlet, such that a height of the junction defines the predetermined liquid level in the liquid retainer.

Example 15: The liquid retention assembly of any of the Examples, where the liquid retainer further comprises a weir that is positioned inside the chamber and that is configured to deflect fluid away from the recirculation outlet.

Example 16: The liquid retention assembly of any of the Examples, where the liquid retainer further comprises an inlet into the chamber, where the inlet into the chamber includes a flow guide that is configured to direct fluid flowing into the chamber through the inlet toward the weir.

Example 17: The liquid retention assembly of any of the Examples, where the liquid retainer comprises: a body defining a chamber; and an outlet tube including an upper end positioned inside of the body and a lower end positioned outside of the body, where a height of the upper end of the outlet tube in the chamber is configured to define the predetermined liquid level in the liquid retainer.

Example 18: The liquid retention assembly of any of the Examples, where the liquid retainer further comprises a sleeve positioned around the upper end of the outlet tube within the chamber such that an annulus is defined between the sleeve and the outlet tube within the chamber, and where the annulus is configured to be in fluid communication with the volume of liquid.

Example 19: The liquid retention assembly of any of the Examples, where the liquid retainer further comprises a second outlet tube that defines the recirculation outlet.

Example 20: The liquid retention assembly of any of the Examples, where the liquid retainer is one of a plurality of liquid retainers of the liquid retention assembly, and where each of the plurality of liquid retainers is configured to retain a corresponding portion of the volume of liquid.

Example 21: The liquid retention assembly of any of the Examples, where the plurality of liquid retainers are connected in series.

Example 22: The liquid retention assembly of any of the Examples, where the plurality of liquid retainers are connected in parallel.

Example 23: A method, comprising: (a) discharging a multi-phase fluid from a pump; (b) receiving the multi-phase fluid into a liquid retention assembly after (a); (c) separating and retaining a liquid from the multi-phase fluid in the liquid retention assembly; and (d) recirculating at least some of the liquid from the liquid retention assembly to the pump to reduce a gas volume fraction (GVF) at an inlet of the pump.

Example 24: The method of any of the Examples, where (c) further comprises: (c1) accumulating at least a portion of the liquid in a liquid retainer of the liquid retention assembly to a predetermined liquid level; and (c2) preventing liquid drainage from the liquid retainer below the predetermined liquid level.

Example 25: The method of any of the Examples, further comprising: (e) flowing a gas-rich stream out of a gas outlet of the liquid retainer; (f) flowing a liquid-rich stream out of a liquid outlet of the liquid retainer; and (g) mixing the liquid-rich stream and the gas-rich stream at a junction downstream of the liquid retainer, where a height of the junction defines a height of the predetermined liquid level in the liquid retainer.

Example 26: The method of any of the Examples, where (c) further comprises separating the multi-phase fluid into a gas and the liquid within the liquid retainer; and where the method further comprises: (h) remixing the gas and the liquid in an outlet tube that has an upper end positioned in a body of the liquid retainer and a lower end positioned outside of the body, where the upper end of the outlet tube defines the predetermined liquid level in the liquid retainer.

Example 27: The method of any of the Examples, where (c) further comprises: (c1) retaining the liquid in a plurality of liquid retainers of the liquid retention assembly such that each liquid retainer of the plurality of liquid retainers has accumulated the liquid to a predetermined liquid level; and (c2) preventing liquid drainage from each liquid retainer of the plurality of liquid retainers below the predetermined liquid level.

Example 28: The method of any of the Examples, where the plurality of liquid retainers are connected in series, downstream of the pump.

Example 29: The method of any of the Examples, where the plurality of liquid retainers are connected in parallel, downstream of the pump.

Embodiments disclosed herein include subsea multi-phase pumping systems equipped with liquid retention assemblies positioned downstream of the pump(s). The liquid retention assemblies are configured to retain a volume of liquid for selective recirculation back to the pump during operations. This recirculated liquid stream may stabilize pump inlet conditions and mitigate the fluctuations in liquid and gas content that otherwise contribute to operational inefficiencies and pump trips. In some embodiments, the liquid retention assemblies include a plurality of liquid retention assemblies arranged in series or in parallel downstream of the pump to increase the capacity of the system to extract and retain liquid for recirculation. Through use of the embodiments disclosed herein, subsea multi-phase pumping systems can achieve improved operational performance without materially increasing system cost, complexity, or footprint.

The preceding discussion is directed to various embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

In the preceding discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used to refer to a stated value, mean within a range of plus or minus 10% of the stated value.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the operations in a method claim may be performed in any order. The recitation of identifiers such as (a), (b), (c) or (1), (2), (3) before operations in a method claim are not intended to and do not specify a particular order to the operations, but rather are used to simplify subsequent reference to such operations.

What is claimed is:

1. A multi-phase pumping system comprising:
a pump; and
a liquid retention assembly downstream of the pump, where the liquid retention assembly is configured to extract and retain a volume of liquid from a multi-phase fluid that is discharged by the pump, and where the liquid retention assembly includes a recirculation outlet that is configured to provide a liquid-rich recirculation flow from the volume of liquid to the pump to reduce a gas volume fraction (GVF) at an inlet of the pump.

2. The multi-phase pumping system of claim 1, where the liquid retention assembly comprises a liquid retainer that is configured to retain at least a portion of the volume of liquid up to a predetermined liquid level and that is configured to prevent liquid drainage below the predetermined liquid level in the liquid retainer.

3. The multi-phase pumping system of claim 2, where the liquid retainer comprises:
a body defining a chamber, where the recirculation outlet is defined on the body;
a liquid outlet out of the chamber;
a gas outlet out of the chamber that is positioned above the liquid outlet, where the gas outlet and the liquid outlet are coupled to one another at a junction positioned outside of the body, and where the junction is positioned above the liquid outlet such that a height of the junction defines the predetermined liquid level in the liquid retainer;
a weir that is positioned inside the chamber and that is configured to deflect fluid away from the recirculation outlet; and
an inlet into the chamber that is coupled to the pump, where the inlet into the chamber includes a flow guide that is configured to direct fluid flowing into the chamber toward the weir.

4. The multi-phase pumping system of claim 2, where the liquid retainer comprises:
a body defining a chamber; and
an outlet tube including an upper end positioned inside of the body and a lower end positioned outside of the body,
where a height of the upper end of the outlet tube in the chamber is configured to define the predetermined liquid level in the liquid retainer.

5. The multi-phase pumping system of claim 4, where the liquid retainer further comprises a sleeve positioned around the upper end of the outlet tube within the chamber such that an annulus is defined between the sleeve and the outlet tube within the chamber, and where the annulus is configured to be in fluid communication with the volume of liquid.

6. The multi-phase pumping system of claim 4, where the liquid retainer further comprises a second outlet tube that defines the recirculation outlet.

7. The multi-phase pumping system of claim 1, where the liquid retention assembly comprises a plurality of liquid retainers that are downstream of the pump, where each of the plurality of liquid retainers is configured to retain a corresponding portion of the volume of liquid.

8. The multi-phase pumping system of claim 7, where the plurality of liquid retainers are connected in series, downstream of the pump.

9. The multi-phase pumping system of claim 7, where the plurality of liquid retainers are connected in parallel, downstream of the pump.

10. The multi-phase pumping system of claim 7, where each liquid retainer of the plurality of liquid retainers is configured to prevent liquid drainage below a predetermined liquid level in the liquid retainer.

11. A liquid retention assembly for a multi-phase pumping system, the liquid retention assembly comprising:
a liquid retainer that is configured to extract and retain at least a portion of a volume of liquid from a multi-phase fluid discharged from a pump of the multi-phase pumping system up to a predetermined liquid level, where the liquid retainer is configured to prevent liquid drainage below the predetermined liquid level; and
a recirculation outlet in communication with the liquid retainer that is configured to provide a liquid-rich recirculation flow from the volume of liquid to the pump to reduce a gas volume fraction (GVF) at an inlet of the pump.

12. The liquid retention assembly of claim 11, where the liquid retainer comprises:
a body defining a chamber, where the recirculation outlet is defined on the body;
a liquid outlet out of the chamber;
a gas outlet out of the chamber that is positioned above the liquid outlet, where the gas outlet and the liquid outlet are coupled to one another at a junction positioned outside of the body, and where the junction is positioned above the liquid outlet, such that a height of the junction defines the predetermined liquid level in the liquid retainer;
a weir that is positioned inside the chamber and that is configured to deflect fluid away from the recirculation outlet; and
an inlet into the chamber, where the inlet into the chamber includes a flow guide that is configured to direct fluid flowing into the chamber through the inlet toward the weir.

13. The liquid retention assembly of claim 11, where the liquid retainer comprises:
a body defining a chamber;
a first outlet tube including an upper end positioned inside of the body and a lower end positioned outside of the body, where a height of the upper end of the first outlet tube in the chamber is configured to define the predetermined liquid level in the liquid retainer;
a sleeve positioned around the upper end of the first outlet tube within the chamber such that an annulus is defined between the sleeve and the first outlet tube within the chamber, where the annulus is configured to be in fluid communication with the volume of liquid; and
a second outlet tube that defines the recirculation outlet.

14. The liquid retention assembly of claim 11, where the liquid retainer is one of a plurality of liquid retainers of the liquid retention assembly, and where each of the plurality of liquid retainers is configured to retain a corresponding portion of the volume of liquid.

15. A method, comprising:
(a) discharging a multi-phase fluid from a pump;
(b) receiving the multi-phase fluid into a liquid retention assembly after (a);
(c) separating and retaining a liquid from the multi-phase fluid in the liquid retention assembly; and
(d) recirculating at least some of the liquid from the liquid retention assembly to the pump to reduce a gas volume fraction (GVF) at an inlet of the pump.

16. The method of claim 15, where (c) further comprises:
(c1) accumulating at least a portion of the liquid in a liquid retainer of the liquid retention assembly to a predetermined liquid level; and
(c2) preventing liquid drainage from the liquid retainer below the predetermined liquid level.

17. The method of claim 16, further comprising:
(e) flowing a gas-rich stream out of a gas outlet of the liquid retainer;
(f) flowing a liquid-rich stream out of a liquid outlet of the liquid retainer; and
(g) mixing the liquid-rich stream and the gas-rich stream at a junction downstream of the liquid retainer, where a height of the junction defines a height of the predetermined liquid level in the liquid retainer.

18. The method of claim 17,
where (c) further comprises separating the multi-phase fluid into a gas and the liquid within the liquid retainer; and where the method further comprises:
(h) remixing the gas and the liquid in an outlet tube that has an upper end positioned in a body of the liquid retainer and a lower end positioned outside of the body, where the upper end of the outlet tube defines the predetermined liquid level in the liquid retainer.

19. The method of claim 15, where (c) further comprises:
(c1) retaining the liquid in a plurality of liquid retainers of the liquid retention assembly such that each liquid retainer of the plurality of liquid retainers has accumulated the liquid to a predetermined liquid level; and
(c2) preventing liquid drainage from each liquid retainer of the plurality of liquid retainers below the predetermined liquid level.

20. The method of claim 19, wherein the plurality of liquid retainers are connected in series or in parallel.
